(19) United States
(12) Patent Application Publication
(10) Pub. No.: US 2017/0174342 A1
(43) Pub. Date: Jun. 22, 2017

(54) Vertical Takeoff Aircraft and Method

(71) Applicant: Deng Huang, Millburn, NJ (US)

(72) Inventor: Deng Huang, Millburn, NJ (US)

(21) Appl. No.: 14/737,702

(22) Filed: Jun. 12, 2015

(51) Int. Cl. B64C 29/00; B64C 39/08; B64C 29/02

(52) U.S. Cl. CPC B64C 29/0033; B64C 29/02; B64C 39/08; B64C 2201/088; B64C 2201/102

(57) ABSTRACT

A tilt wing aircraft has a spaced plurality of wings mounted on a fuselage to pivot in unison about corresponding ones of a parallel plurality of tilt axes, between an upright position and a cruise position. In the cruise position the wings are disposed edge to edge with a gap less than the width of any of the plurality of wings, as measured at the fuselage. A plurality of power units are mounted on one or more of the wings to rotate in unison with them between a vertical propulsion position and a forward propulsion position. Said plurality of power units can rotate into the vertical propulsion position as the wings rotate into the upright position. The wings are placed in an upright position with the power units positioned to provide vertical propulsion. When powered, the power units can create a downdraft between the wings in order to lift the fuselage. The wings and the power units are rotated to reduce their angles of attack and facilitate forward motion of the fuselage.

### BACKGROUND OF THE INVENTION

1. Field of the Invention

The present invention relates to vertical takeoff aircraft, and in particular, to aircraft and methods involving wings that can tilt with respect to a fuselage

2. Description of Related Art

Conventional fixed wing aircraft employ an airfoil with a rounded leading edge followed by a sharp trailing edge. This aerodynamic shape creates lift when the wing rapidly passes through an airstream. Aircraft with this type of wing requires a rather long runway to allow the aircraft to gain adequate speed before its wings create sufficient lift to sustain flight. Long runways are also needed because such aircraft will touch down at rather high speeds and must travel a significant distance before slowing sufficiently to allow turning and stopping.

In many environments a long runway is not feasible either because of the terrain, or because of economic considerations. Understandably, aircraft capable of achieving flight without a long runway are highly desirable. Helicopters can accomplish vertical takeoff or landing, but have serious disadvantages in comparison to conventional fixed wing aircraft. In particular, helicopters are relatively fuel-inefficient and therefore not favored for long journeys. In addition the traveling speed of helicopter's is rather limited.

For this reason, fixed wing aircraft have been designed with the ability to accomplish vertical takeoff or landing (VTOL), or short takeoff or landing (STOL). The Bell Boeing V-22 Osprey is an aircraft that carries on the tips of its fixed wings, rotors that can tilt over a range of about 90°. When the axes of the rotors are vertically oriented, they produce a downdraft that lifts the aircraft vertically. Once airborne, the rotors can be gradually tilted down to produce forward propulsion, allowing the aircraft to fly much like a conventional fixed wing aircraft. The rotors can be vertically oriented again for the purpose of slowing the travel speed and landing. However, during these vertical maneuvers, the downdraft of the rotors bear directly against the relatively flat surface of the fixed wing, which reduces efficiency and increases stress.

The RAF Harrier Jump Jet combat aircraft employs a jet engine with four exhaust nozzles that can be rotated to produce vertical thrust or forward thrust This aircraft has a fixed wing and can achieve relatively high speed due to its jet engine. On the other hand, a landing field can quickly erode from the downward blast of a jet engine.

Some VTOL aircraft carry engine-driven rotors on their wings, and both the wings and engines can together tilt 90° to achieve vertical takeoff/landing. The Ling-Temco-Vought XC-142A and the Canadair CL-84 aircraft have such wings When these wings are tilted up, they present a large static area, much like a sail, that is affected by destabilizing wing gusts.

See also U.S. Pat. Nos. 3,081,964; 3,184,181; 3,197,157; 5,098,034; 6,659,394; 7,118,066; 8,505,846; and 8,708,273; as well as U.S. Patent Application Publication Nos. 2003/0080242; and 2005/0230519; and also Chinese Patent Publication CN201494624.

### SUMMARY OF THE INVENTION

In accordance with the illustrative embodiments demonstrating features and advantages of the present invention, there is provided a tilt wing aircraft with a spaced plurality of wings mounted on a fuselage. These wings pivot in unison about corresponding ones of a parallel plurality of tilt axes, between an upwardly oriented position and a forwardly oriented position. The wings each have a wing length and, at the fuselage, a proximal width that is less than the wing length. In the forwardly oriented position, the wings have wing-to-wing gaps that are each less than the proximal width of any of the wings. The aircraft also has power units mounted on one or more of the wings. The power units can rotate in unison with the wings between a vertical propulsion position and a forward propulsion position. The power units can rotate into the vertical propulsion position as the wings rotate into the upwardly oriented position

In accordance with another aspect of the invention, a method is provided for enabling a vertical takeoff capability. The method employs a number of spaced wings that are pivotally mounted on an aircraft fuselage. The wings support a plurality of power units. The method includes the step of placing the plurality of wings in an upwardly oriented position with the power units in a position to provide upward propulsion. Another step is powering the power units sufficiently to create a downwash in order to lift the fuselage. The method also includes the step of rotating the wings about a spaced plurality of tilt axes. The power units can rotate about one or more of the axes. The method includes the step of reducing the angle of attack of the plurality of wings in order to facilitate forward motion of the fuselage and maintaining between them wing to wing gaps that are each less than the width of any of the plurality of wings as measured at the fuselage.

In accordance with yet another aspect of the invention, a tilt wing aircraft is provided. The aircraft has a spaced plurality of wings mounted on a fuselage to pivot in unison about corresponding ones of a parallel plurality of tilt axes between an upwardly oriented position and a forwardly oriented position. The tilt axes are coplanar. The wings each have a wing length and, at the fuselage, a proximal width that is less than the wing length. In the forwardly oriented position, the wings are disposed with wing to wing gaps that are each less than the proximal width of any of the wings. Each of the wings is shaped to produce lift and have a rounded leading edge tapering toward a narrower trailing edge. In the upright position, the leading edge is higher than the trailing edge. The trailing edge of each of the wings has a central notch providing clearance for swinging into the upright position and straddling the fuselage. Each of the wings has at least one distal tip. The wings include a medial one that runs athwart the fuselage, terminating in a right and a left distal tip. This medial one has at its right distal tip a leading right connector and a trailing right connector adjacent to the leading and the trailing edge, respectively. The medial one has at its left distal tip a leading left connector and a trailing left connector adjacent to the leading and the trailing edge, respectively. The aircraft also has a right and a left power unit. The right power unit is mounted on the leading right connector and the trailing right connector. The left power unit is mounted on the leading left connector and the trailing left connector. The power units are mounted to rotate in unison with the wings about the tilt axis of the medial one of the plurality wings, between a vertical propulsion position and a forward propulsion position. The power units each have a rotor. The power units can rotate into the vertical propulsion position as the wings rotate into the upwardly oriented position. Also included is a mechanism that is located in the fuselage and is linked to each of the wings for rotating them synchronously. The aircraft also has a right and a left brace that are rotatably connected to the distal tips located on the left and on the right, respectively, of the fuselage. The right brace has a pair of concavities providing clearance in the forwardly oriented position for the leading right connector and the trailing right connector, respectively. The left brace has a pair of concavities providing clearance in the forwardly oriented position for the leading left connector and the trailing left connector, respectively. The aircraft also has a pair of ailerons mounted on some of the plurality of wings, as well as a tail with a rudder and a pair of elevators.

By employing apparatus and methods of the foregoing type, an improved tilt wing aircraft is achieved. Compared to existing tilt wing aircrafts, the new design allows larger lift area during cruise than cross area during hover, thus improving maneuverability and efficiency. In one disclosed embodiment the aircraft has a trio of tiltable wings, each extending across the fuselage of the aircraft. The wings can rotate in unison between an upright position and a forward position. In the forward position the three wings are closely spaced, edge to edge, and operate much like an ordinary single-wing aircraft wing. In a disclosed embodiment the trailing edge of each of the wings has a central notch providing clearance for swinging into the upright position and straddling the fuselage.

In this embodiment, two engine nacelles are supported on the right and left tips of the middle one of the trio of tiltable wings. The engine nacelles rotate in unison with the trio of wings. The medial wing has at each distal tip a leading nacelle connector and a trailing nacelle connector adjacent to the leading and the trailing edge, respectively. The disclosed aircraft also has a right and a left brace that are rotatably connected to the distal tips located on the left and on the right, respectively, of the fuselage. Also included is a mechanism that is located in the fuselage and is linked to each of the wings for rotating them synchronously. The aircraft also has a pair of ailerons mounted on some of the plurality of wings, as well as a tail with a rudder and a pair of elevators.

In the upright position, the disclosed rotors provide a downwash that flows easily past the wings, which are in an upright position and present a small cross-section to the downwash. Under these circumstances, the rotors provide a vertical lift, allowing the aircraft to rise vertically. Thereafter, the trio of wings and the engine nacelles can be gradually rotated toward the forward position, causing the aircraft to move forward at a progressively increasing speed. Eventually the wings and the engine nacelles will be in a forward position, allowing the aircraft to travel much like a fixed wing aircraft. This process can be reversed when landing the aircraft.

In another disclosed embodiment, the aircraft has a pair of tiltable wings near the cockpit, and another pair of tiltable wings near the tail of the aircraft. In this embodiment the rear pair of wings is longer than the front pair. The wings of both pairs can rotate in unison between a position where all are upright and another position where all are pointing forward. In this embodiment a pair of engine nacelles is mounted on the front pair of wings, specifically on the underside of the foremost wing. Another pair of engine nacelles is mounted on the rear pair of wings, specifically on the underside of the foremost wing of that pair. Because of their positioning, the engine nacelles in this embodiment can swing without interference. As before, the wings and engine nacelles rotate to allow vertical takeoff, followed by forward propulsion.

### BRIEF DESCRIPTION OF THE DRAWINGS

The above brief description as well as other objects, features and advantages of the present invention will be more fully appreciated by reference to the following detailed description of illustrative embodiments in accordance with the present invention when taken in conjunction with the accompanying drawings, wherein.

FIG. 1 is a plan view of a dual-rotor embodiment of the tilt wing aircraft in accordance with principles of the present invention;

FIG. 2 is a side elevational view of the aircraft of FIG. 1;

FIG. 3 is a front elevational view of the aircraft of FIG. 1;

FIG. 4 is a plan view of the aircraft of FIG. 1 with its tiltable wings and propulsion units tilted into their vertical takeoff positions;

FIG. 5 is a side elevational view of the aircraft of FIG. 4;

FIG. 6 is a front elevational view of the aircraft of FIG. 4;

FIG. 7 is a perspective, fragmentary view of the left end of the tiltable wings of the aircraft of FIG. 4;

FIG. 8 is an exploded, perspective view of a portion of the aircraft of FIG. 4;

FIG. 9 is a plan view of a quad-rotor embodiment of the tilt wing aircraft in accordance with principles of the present invention;

FIG. 10 is a side elevational view of the aircraft of FIG. 9;

FIG. 11 is a front elevational view of the aircraft of FIG. 9;

FIG. 12 is a plan view of the aircraft of FIG. 9 with its tiltable wings and propulsion units tilted into their vertical takeoff positions;

FIG. 13 is a side elevational view of the aircraft of FIG. 12;

FIG. 14 is a front elevational view of the aircraft of FIG. 12;

FIG. 15 is a perspective, fragmentary view of the left end of one of the pair of tiltable wings of the aircraft of FIG. 12; and

FIG. 16 is an exploded, perspective view of a portion of the aircraft of FIG. 12.

### DETAILED DESCRIPTION

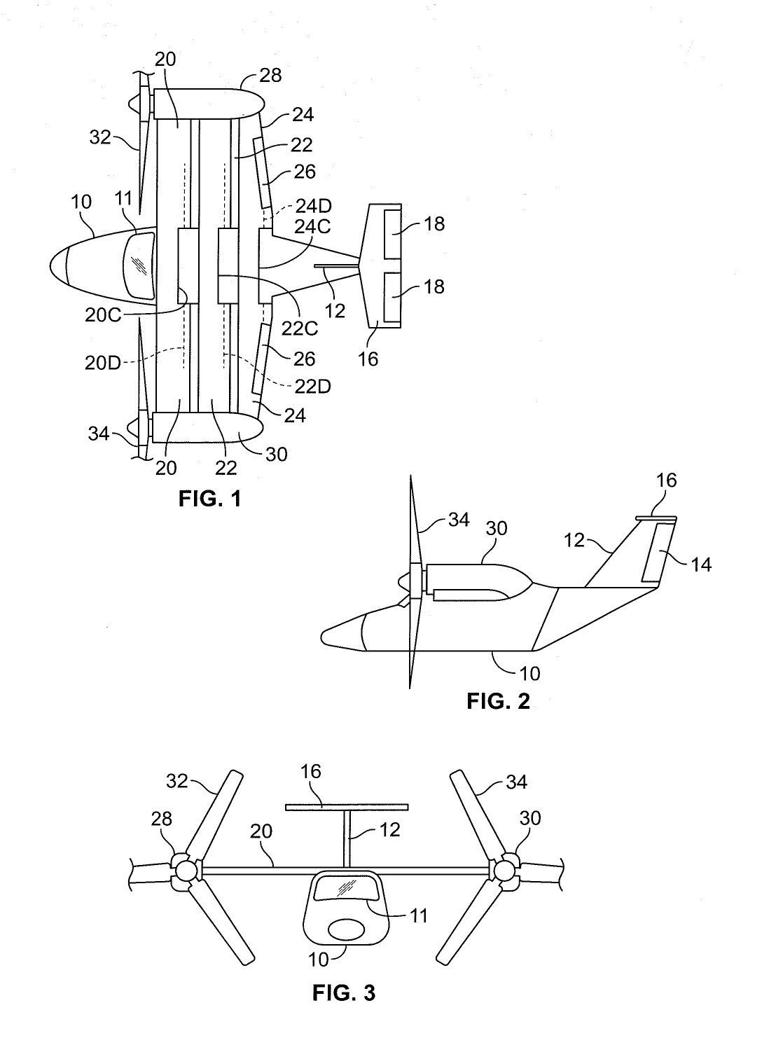

Referring to FIGS. 1-3, the illustrated tilt wing aircraft has a fuselage 10 with a cockpit located behind windshield 11. The tail of fuselage 10 has a vertical stabilizer 12 with a rudder 14. Mounted atop stabilizer 12 is horizontal stabilizer 16, which has two elevators 18.

Mounted across fuselage 10 are three tiltable wings: foremost wing 20, medial wing 22, and rear wing 24. Wings 20, 22, and 24 (also referred to as primary wings) are mounted to rotate about tilt axes 20D, 22D, and 24D, respectively. Tilt axes 20D, 22D, and 24D are transverse to the longitudinal axis of fuselage 10. Wings 20, 22, and 24 are shown in their forwardly oriented positions, which establishes an angle of attack similar to that found in ordinary fixed wing aircraft. While tilt axes 20D, 22D, and 24D are coplanar in this embodiment, their common plane need not be parallel to the longitudinal axis of fuselage 10. In some cases the wings 20, 22, and 24 may be at different heights (arranged like a staircase) to enhance the airflow and combined lift.

The overall width of wings 20, 22, and 24, from leading to trailing edge, as measured at a location next to fuselage 10, is referred to as the proximal width at fuselage 10. This proximal width is much less than the corresponding wing length, that is, less than the overall length of each of the wings 20, 22, and 24 as measured along axes 20D, 22D, and 24D, respectively. In this embodiment wings 20, 22, and 24 have about the same length from their right distal tips to their left distal tips.

In this forwardly oriented position, the wing to wing gap between wings 20 and 22 (and between wings 22 and 24) is less than the proximal width of any of the wings. In some embodiments, the proximal width of each of the wings 20, 22, and 24 is at least five times greater than the wing to wing gap between any of the adjacent wings (with wings oriented as shown), although satisfactory performance will be achieved when the proximal width is at least two times greater than the wing to wing gap between any of the adjacent wings. In some embodiments the wing to wing gap during normal cruising will be reduced to zero, at which time the wings 20, 22 will operate like a single wing.

Right power unit 28 is attached to the right end of wing 22, and left power unit 30 is attached to the left end of wing 22. Accordingly, power units 28 and 30 will tilt in unison with medial wing 22 about axis 22D (this axis also referred to as the central, designated one of the axes). Power units 28 and 30 are shown in the forward propulsion position and point forward much like wing 22. Power units 28 and 30 are nacelles containing engines that drive rotors 32 and 34, respectively. The engines of power units 28 and 30 may be piston or turbine engines powered by combustible hydrocarbon-based fuel, although other engine types may be employed instead.

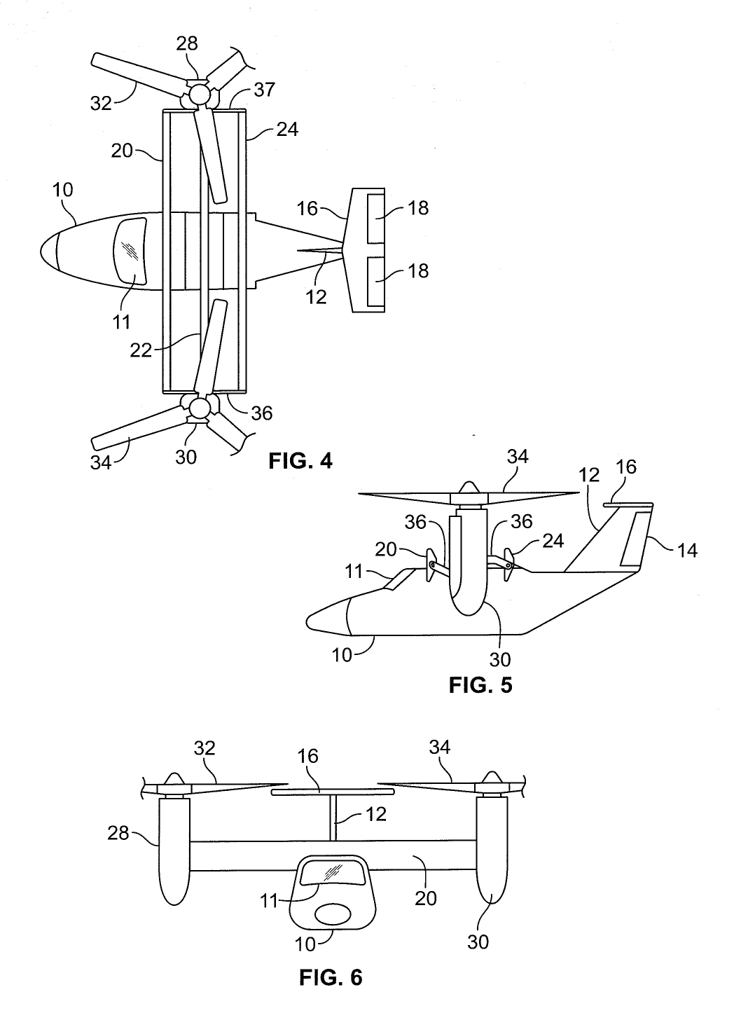

Referring to FIGS. 4-6, the previously illustrated aircraft is shown with its wings 20, 22, and 24 tilted into an upwardly oriented position. Basically, wings 20, 22, and 24 have rotated from their previously described position by approximately 90° (90° clockwise when viewed from the left-hand side shown in FIG. 5). Power units 28 and 30 rotate together since they are mounted on the right and left ends, respectively, of medial wing 22. In particular, power units 28 and 30 are shown in an upward propulsion position with their rotors 32 and 34 facing upwardly for producing a downwash between wings 20, 22, and 24.

Components 20, 22, 24, 28 and 30 can point upwardly, but can also be tilted to point backwardly to some extent (e.g., 5° or 10° backward tilt). Moreover, components 20, 22, 24, 28 and 30 can point forwardly as shown in FIGS. 1-3, but can also be tilted to point downwardly to some extent (e.g., 5° or 10° downward tilt).

In FIG. 5, brace 36 is shown pivotally connected to the left ends of wings 20 and 24. Brace 36 is also pivotally attached to the left end of wing 22 as will be described presently. Brace 37 is similarly connected to right ends of wings 20, 22 and 24 and is arranged as the mirror image of brace 36.

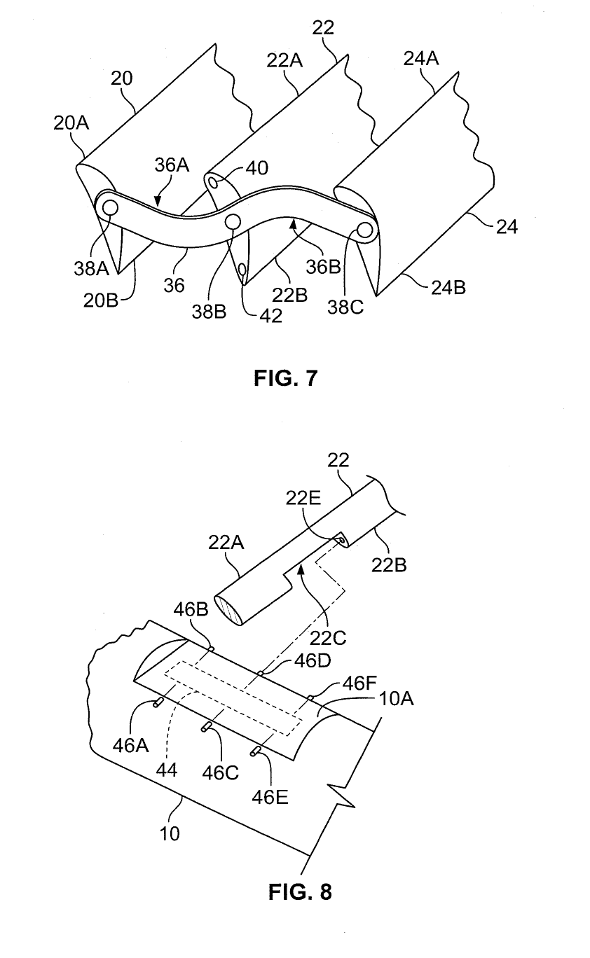

Referring to FIG. 7, previously mentioned left brace 36 is shown pivotally connected to wings 20, 22, and 24 by studs 38A, 38B, and 38C, respectively. Studs 38A, 38B, and 38C have inner shanks (not shown) that are affixed to the wings 20, 22, and 24, pass through the brace 36, and terminate in outer flanges that capture the brace. Appropriate bearings (not shown) may be used to facilitate rotation of wings 20, 22, and 24 relative to brace 36.

Wings 20, 22, and 24 are shown with rounded leading edges 20A, 22A, and 24A, respectively, and narrower trailing edges 20B, 22B, and 24B, respectively. Wings 20, 22, and 24 are shown in their upwardly oriented positions where leading edges 20A, 22A, and 24A are higher than trailing edges 20B, 22B, and 24B

The left distal tip of wing 22 is shown with a leading left connector 40, and a trailing left connector 42. Connectors 40 and 42 are threaded bores that can be used to bolt the previously mentioned left power unit (unit 30 of FIG. 5) onto the distal tip of wing 22.

Brace 36 has an inverted tilde (˜) shape, which provides concavities 36A and 36B. Concavities 36A and 36B provide clearance that allows bolts in connectors 40 and 42 to travel 90° counterclockwise (from the position shown in this view) and achieve the forwardly oriented position of FIG. 1. It will be appreciated that previously mentioned right brace 37 is connected in a similar manner and that that arrangement would appear as the mirror image of that shown in FIG. 7

Referring to FIG. 8, previously mentioned medial wing 22 has along its trailing edge 22B, center notch 22C (i.e. the foregoing provides a centrally notched trailing edge). Notch 22C is designed to straddle fuselage 10 at the plateau 10A formed in the fuselage.

Mechanism 44, shown in phantom, is mounted inside fuselage 10. Releasably attached to mechanism 44 are: (1) an aligned pair of front drive shafts 46A and 46B, (2) an aligned pair of medial drive shafts 46C, and 46D, and (3) an aligned pair of aft drive shafts 46E and 46F. Drive shafts 46A-46F are synchronously driven by mechanism 44 so each delivers the same angular displacement. Mechanism 44 may achieve such synchronism by means of a gear train or by servomotors designed to maintain synchronism.

The right and left faces of notch 22C each have connectors, right connector 22E being visible in this view. Drive shaft 46D is designed to attach to connector 22E. It will be understood that drive shaft 46C will attach to a connector (not shown) on the opposing left face of notch 22C. Shafts 46C and 46D may be secured by means of threads, splines, welding, etc.

It will be further understood that drive shafts 46A and 46B attach in a similar fashion into a notch in foremost wing 20 (see notch 20C of FIG. 1). Likewise, rear wing 24 has a notch (see notch 24C of FIG. 1) and attaches to drive shafts 46E and 46F, also in a similar fashion. Accordingly, mechanism 44 can cause wings 20, 22, and 24 to rotate synchronously and maintain essentially the same angle of attack. Moreover, power units 28 and 30 (FIGS. 1-6) maintain essentially the same angle of attack since they are attached to the distal tips of medial wing 22 by means of connectors 40 and 42 (FIG. 7)

To facilitate an understanding of the principles associated with the foregoing apparatus, its operation will be briefly described. The aircraft of FIGS. 4-6 is initially parked in a launch pad, resting on its landing gear (not shown). The power units 28 and 30 are then started to rotate rotors 32 and 34 at a high speed. The resulting downwash tends to lift fuselage 10. Because wings 20, 22, and 24 are upright they present a small cross-section and little interference to the downwash from rotors 32 and 34.

Rotors 32 and 34 rotate in opposite directions so as to avoid a torque that would tend to turn fuselage 10 azimuthally. Also, the power delivered by a units 28 and 30 are balanced to avoid rolling of fuselage 10. In addition, the angle of wing 22 and units 28 and 30 can be adjusted to establish a desired angle of elevation for fuselage 10. The aircraft will then be hovering and capable of some horizontal movement. The pitch of the aircraft can be adjusted to create forward or backward motion by adjusting the angles of wings 20, 22, and 24. The roll of the aircraft can be adjusted to right and left motion by changing the power balance between power units 28 and 30. In some embodiments, the blade pitch of the rotors 32, and 34 can be cyclically adjusted during 360° of rotation to produce a lateral displacement, much like a helicopter blade.

As power is increased and the aircraft rises, mechanism 44 (FIG. 8) will be operated to gradually rotate wings 20, 22, and 24, as well as power units 28 and 30, to reduce their angle of attack, that is, to point them more towards a forwardly oriented direction. This tilting changes the propulsion vector so that rotors 32 and 34 produce less lift but more forward propulsion. This tilting is performed at a sufficient altitude to minimize the risk of the aircraft touching down again while it is gathering forward speed. Once forward motion has begun rudder 14, elevators 18, and ailerons 26 will be operated in the usual manner to maintain aircraft stability.

As forward speed increases wings 20, 22, and 24 will create a lift that replaces the lift formerly provided by rotors 32 and 34 when they were pointing upwardly. Eventually the aircraft will reach a cruising speed as the wings 20, 22, and 24, and power units 28 and 30 move to the positions shown in FIGS. 1-3 Under these conditions, the aircraft will fly much like an ordinary fixed wing aircraft.

When the aircraft reaches its destination the foregoing process will be reversed. Specifically, wings 20, 22, and 24, and power units 28 and 30 will be gradually tilted upwardly to increase their angle of attack. This will gradually reduce the lift provided by wings 20, 22, and 24, while increasing the lift provided by rotors 32 and 34. The higher angle of attack for rotors 32 and 34 also reduces forward propulsion so the aircraft will decelerate. Eventually wings 20, 22, and 24 and power units 28 and 30 will be pointing upwardly as shown in FIGS. 4-6, at which time the aircraft will be hovering. The power from units 28 and 30 will be gradually decreased so the aircraft gently descends and lands.

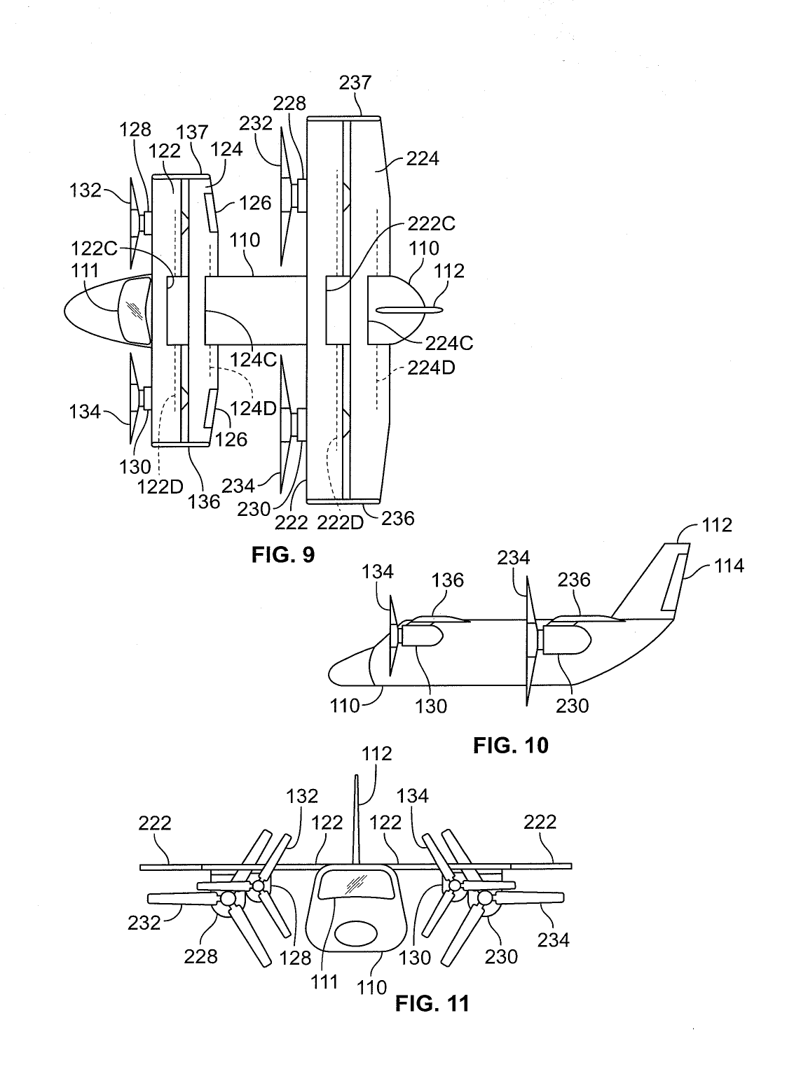

Referring to FIGS. 9-11, an alternate embodiment is illustrated with a pair of tiltable wings 122 and 124 mounted on fuselage 110 toward the front, while located toward the rear are a pair of tiltable wings 222 and 224. Components corresponding to those previously illustrated in FIGS. 1-8 bear the same reference numerals but increased by 100, except that the reference numerals are increased by 200 for rear wings 222 and 224 and the components mounted on those rear wings.

As before this tilt wing aircraft has a cockpit located behind windshield 111, and the tail of fuselage 110 has a vertical stabilizer 112 Mounted across fuselage 110 near windshield 111 are two tiltable wings: foremost wing 122, and rear wing 124. Wings 122 and 124 (also referred to as primary wings) are mounted to rotate about tilt axes 122D and 124D, respectively. Tilt axes 122D and 124D are transverse to the longitudinal axis of fuselage 110. Wings 122 and 124 are shown in their forwardly oriented positions, which establishes an angle of attack similar to that found in ordinary fixed wing aircraft.

The overall width of wings 122 and 124, from leading to trailing edge, as measured at a location next to fuselage 10, is referred to as the proximal width at fuselage 10. This proximal width is much less than the corresponding wing length, that is, less than the overall length of each of the wings 122 and 124 as measured along axes 122D and 124D, respectively. In this embodiment, wings 122, and 124 have about the same length from their right distal tips to their left distal tips. In this forwardly oriented position, the wing to wing gap between wings 122 and 124 is less than the proximal width of any of those two wings. The gap may be proportioned as described for the previous embodiment.

As before, wings 122 and 124 have notches 122C and 124C, respectively, that allow these wings to straddle fuselage 110 and pivot about axes 122D and 124D, respectively. Also, wings 122 and 124 may be driven to pivot synchronously by a mechanism similar to that shown in FIG. 8

Right power unit 128 is attached to the underside of wing 122 on the right, and left power unit 130 is attached to the underside of wing 122 on the left. Accordingly, power units 128 and 130 will tilt in unison with wing 124 about axis 124D. Power units 128 and 130 are shown in the forward propulsion position and point forward much like wing 122. Power units 128 and 130 are nacelles containing engines that drive rotors 132 and 134, respectively. The engines of power units 128 and 130 may be piston or turbine engines powered by combustible hydrocarbon-based fuel, although other engine types may be employed instead.

Mounted across fuselage 110 near vertical stabilizer 112 are two tiltable wings: foremost wing 222, and rear wing 224. Wings 222 and 224 (also referred to as complementary wings) are mounted to rotate about complementary axes 222D and 224D, respectively. Complementary axes 222D and 224D are transverse to the longitudinal axis of fuselage 110. Wings 222 and 224 are shown in their forwardly oriented positions, which establishes an angle of attack similar to that found in ordinary fixed wing aircraft.

The overall width of wings 222 and 224, from leading to trailing edge, as measured at a location next to fuselage 110, is referred to as the proximal width at fuselage 110. This proximal width is much less than the corresponding wing length, that is, less than the overall length of each of the wings 222 and 224 as measured along axes 222D and 224D, respectively. In this embodiment wings 222, and 224 have about the same length from their right distal tips to their left distal tips. In this forwardly oriented position, the wing to wing gap between wings 222 and 224 is less than the proximal width of any of those two wings. The gap may be proportioned as described for the earlier embodiment of FIGS. 1-8.

As before, wings 222 and 224 have notches 222C and 224C, respectively, that allow these wings to straddle fuselage 110 and pivot about axes 222D and 224D, respectively. Also, wings 222 and 224 may be driven to pivot synchronously by a mechanism that will be described presently.

Right propulsion unit 228 is attached to the underside of wing 222 on the right, and left propulsion unit 230 is attached to the underside of wing 222 on the left. Accordingly, propulsion units 228 and 230 will rotate in unison with wing 222 about axis 222D. Propulsion units 228 and 230 are shown in the forward propulsion position and point forward much like wing 222. Propulsion units 228 and 230 are nacelles containing engines that drive rotors 232 and 234, respectively. The engines of propulsion units 228 and 230 may be piston or turbine engines powerd by combustible hydrocarbon-based fuel, athough other engine types may be employed instead.

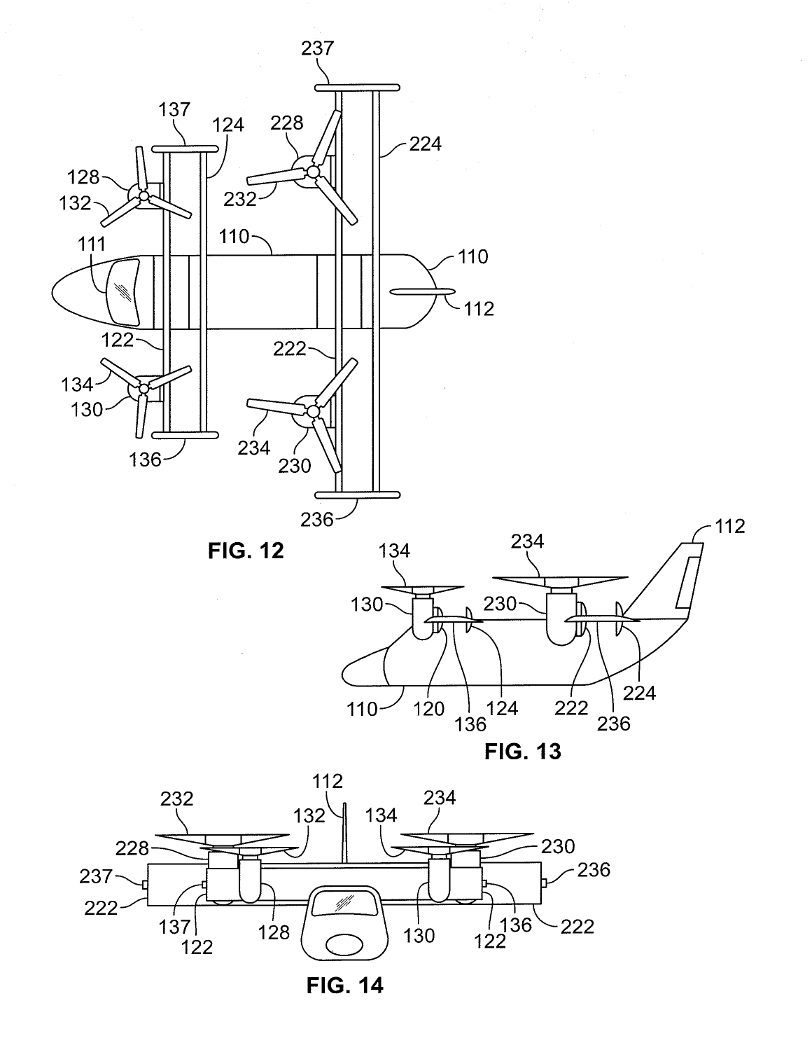

Referring to FIGS. 12-14, the previously illustrated aircraft is shown with its wings 122 and 124 rotated into an upwardly oriented position. Basically, wings 122 and 124 have rotated from their previously described position by approximately 90° (90° clockwise when viewed from the left-hand side shown in FIG. 13). Propulsion units 128 and 130 rotate together since they are both mounted under wing 122. In particular, propulsion units 128 and 130 are shown in an upward propulsion position with their rotors 132 and 134 facing upwardly to produce a downwash between wings 122 and 124.

Wings 222 and 224 are shown rotated into an upwardly oriented position. Basically, wings 222 and 224 have rotated from their previously described position by approximately 90° (90° clockwise when viewed from the left-hand side shown in FIG. 13). Propulsion units 228 and 230 rotate together since they are both mounted under wing 222. In particular, propulsion units 228 and 230 are shown in an upward propulsion position with their rotors 232 and 234 facing upwardly to produce a downwash between wings 222 and 224.

In FIG. 12, brace 236 is shown pivotally connected to the left ends of wings 222 and 224. Brace 237 is similarly connected to right ends of wings 222 and 224 and is arranged as the mirror image of brace 236.

Also, brace 136 is shown pivotally connected to the left ends of wings 122 and 124 Brace 137 is similarly connected to right ends of wings 122 and 124 and is arranged as the mirror image of brace 136.

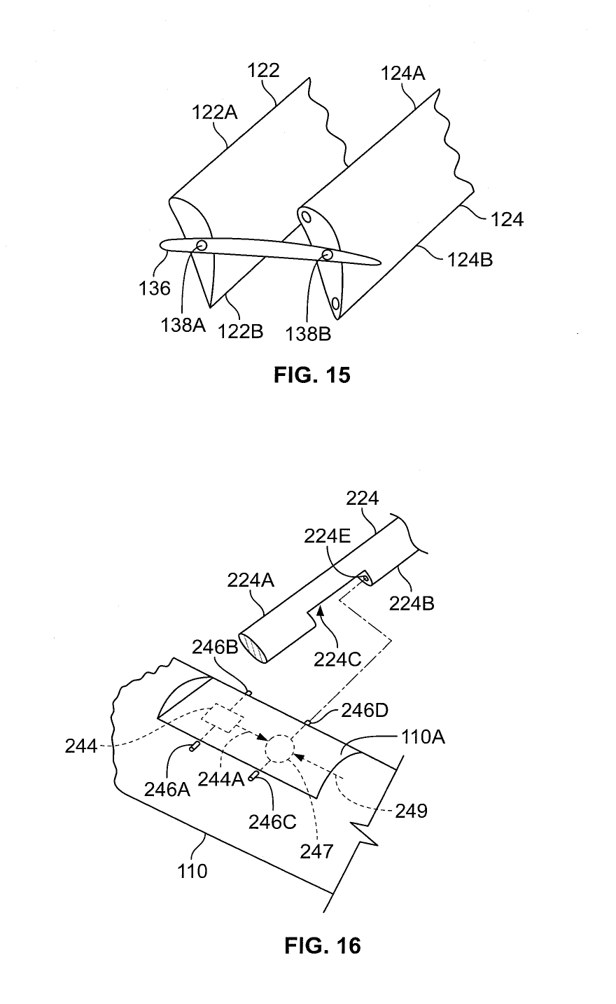

Referring to FIG. 15, previously mentioned left brace 136 is shown pivotally connected to wings 122 and 124 by studs 138A and 138B, respectively. Studs 138A and 138B have structures similar to the previously described studs (studs 38A, 38B, and 38C of FIG. 7). As before, wings 122 and 124 have rounded leading edges 122A and 124A, respectively, and narrower trailing edges 122B and 124B, respectively. It will be appreciated that previously mentioned right brace 137 is connected in a similar manner and that that arrangement would appear as the mirror image of that shown in FIG. 15. Furthermore, previously mentioned braces 236 and 237 (FIG. 12) will be structured and attached in a manner similar to that illustrated in this FIG. 15.

Referring to FIG. 16, mechanism 244 (shown in phantom) is mounted inside fuselage 110. Releasably attached to mechanism 244 are an aligned pair of synchronized front drive shafts 246A and 246B that are designed to attach to previously mentioned wing 222 (specifically to the inside faces of notch 222C of FIG. 9)

Mechanism 244 has an output shaft 244A that rotates synchronously with shafts 246A and 246B. Shaft 244A is connected to one input of differential drive 247, whose other input is connected to control shaft 249. Differential drive 247 has an aligned pair of synchronized output drive shafts 246C and 246D that are designed to connect to connectors in the right and left faces of notch 224C in the trailing edge of wing 224 (right connector 224E is visible in this view). Shafts 246A, 246B, 246C and 246D may be secured by means of threads, splines, welding, etc. Notch 224C (as well as notch 222C of FIG. 9) is designed to straddle fuselage 110 at the plateau 110A formed in the fuselage

Differential drive 247 positions output shafts 246C and 246D at an angle that is the difference between the angular positions of input shafts 244A and 249. If shaft 249 a stationary, shaft 244A will cause shafts 246C and 246D to rotate synchronously with shafts 246A and 246B. Shaft 249 will be used to produce an angular offset between synchronous shafts 246A and 246B on the one hand, and synchronous shafts 246C and 246D on the other hand. For example, shaft 249 can be turned to an angular setting where shafts 246A and 246B are offset to produce a slightly higher or slightly lower angle of attack than shafts 246C and 246D. As explained further hereinafter, control shaft 249 can be used to adjust the angle of attack of wing 224 so it operates much like an elevator in a conventional fixed wing aircraft.

To facilitate an understanding of the principles associated with the foregoing apparatus of FIGS. 9-16, its operation will be briefly described. The aircraft of FIGS. 12-14 is initially parked in a launch pad, resting on its landing gear (not shown). The units 128, 130, 228, and 230 are then started to spin rotors 132, 134, 232, and 234 at a high speed. The resulting downwash tends to lift fuselage 110 Because wings 122, 124, 222, and 224 are upright, they present a small cross-section and little interference to the downwash from rotors 132, 134, 232, and 234.

Rotors 132 and 134, as well as rotors 232 and 234, are counter-rotating and are balanced to avoid undesired roll or pitch. In addition, the angle of wings 122 and 222 and units 128, 130, 228 and 230 can be adjusted to establish a desired angle of elevation for fuselage 110. Under these circumstances, the aircraft can hover. The balance of units 128, 130, 228, and 230 can be adjusted to adjust the roll and pitch of the hovering aircraft, enabling it to move horizontally in any direction (360° possibility). In some embodiments, the blade pitch of the rotors 132, 134, 232, and 234 can be cyclically adjusted during 360° of rotation to produce a lateral displacement, much like a helicopter blade.

As additional power is supplied and the aircraft rises, wings 122, 124, 222, and 224 as well as units 128, 130, 228 and 230, are gradually swung downwardly. Mechanisms 244 and 247 control the tilting of wings 222 and 224, while a mechanism similar to mechanism 44 of FIG. 8 controls wings 122 and 124. Basically, the angles of attack of wings 122, 124, 222, and 224 are reduced to point the wings more towards a forwardly oriented direction. This tilting changes the propulsion vector in that rotors 132, 134, 232, and 234 produce less lift but more forward propulsion. This tilting is performed at a sufficient altitude to minimize the risk of the aircraft touching down again while it is gathering forward speed.

Once forward motion has begun, rudder 114, and ailerons 126 will be operated in the usual manner to maintain aircraft stability. In addition wing 224 can be angularly offset relative to wing 222 to act as an elevator. As previously mentioned, this angular offset can be produced by a changing the angular setting of shaft 249 to produce an offset through differential drive 247 (FIG. 16).

As forward speed increases, wings 122, 124, 222, and 224 will create a lift that replaces the lift formerly provided by rotors 132, 134, 232 and 234 when they were pointing upwardly. Eventually the aircraft will reach a cruising speed as the wings 122, 124, 222, and 224, and units 128, 130, 228 and 230 move to the positions shown in FIGS. 9-11

When the aircraft reaches its destination the foregoing process will be reversed. Specifically, wings 122, 124, 222, and 224, and power units 128, 130, 228 and 230 will be gradually tilted upwardly to increase their angle of attack. This will gradually reduce the lift provided by wings 122, 124, 222 and 224, while increasing the lift provided by rotors 132, 134, 232 and 234. The higher angle of attack for rotors 132, 134, 232 and 234 also reduces forward propulsion so the aircraft will decelerate. Eventually wings 122, 124, 222, and 224, and units 128, 130, 228 and 230 will be pointing upwardly as shown in FIGS. 12-14, at which time the aircraft will be hovering. Finally, the power from units 128, 130, 228, and 230 will be gradually decreased so the aircraft gently descends and lands.

It is appreciated that various modifications may be implemented with respect to the above described embodiments. While one embodiment employed a trio of tiltable wings with power units on the tips of the middle wing, other embodiments can employ a different number of wings and can mount the power units under the foremost wing or elsewhere. While one embodiment employed a pair of tiltable wings in front and another pair of tiltable wings in back, other embodiments can employ a different number, and the number in front can be different than the number in back. Also, the rotors need not be employed with a single rotor on the right and a single rotor on the left, and instead multiple rotors can be employed on the right, and multiple rotors can be employed on the left. Also, the aircraft can be designed as a military aircraft, an unmanned drone, or as commercial aircraft for carrying passengers or cargo. In some cases the aircraft can be fitted with landing wheels, skis, or floating pontoons, depending on the type of launch and landing sites contemplated. While the illustrated tiltable wings extend across the fuselage from right to left as an integral unit, in some cases separate right and left wings will be employed. Instead of propulsion being provided by rotors, some embodiments may employ jet engines, or a combination of rotors and jet engines

Obviously, many modifications and variations of the present invention are possible in light of the above teachings. It is therefore to be understood that within the scope of the appended claims, the invention may be practiced otherwise than as specifically described.

1. A tilt wing aircraft comprising:
a fuselage;
a spaced plurality of primary wings mounted on said fuselage to pivot in unison about corresponding ones of a parallel plurality of tilt axes between an upwardly oriented position and a forwardly oriented position, said plurality of primary wings each having a wing length and at said fuselage a proximal width that is less than said wing length, in said forwardly oriented position said plurality of primary wings having wing-to-wing gaps that are each less than the proximal width of any of the plurality of primary wings; and
a plurality of power units mounted on one or more of said plurality of primary wings to rotate in unison with said plurality of primary wings between an upward propulsion position and a forward propulsion position, said plurality of power units being operable to rotate into said upward propulsion position as said plurality of primary wings rotate into said upwardly oriented position.

2. A tilt wing aircraft according to claim 1 wherein each of said plurality of primary wings have at least one distal tip, said aircraft comprising:
a right and a left brace rotatably connected to the distal tips located on the left and on the right, respectively, of said fuselage.

3. A tilt wing aircraft according to claim 2 wherein at least one of said plurality of primary wings is shaped to produce lift and has a rounded leading edge tapering toward a narrower trailing edge.

4. A tilt wing aircraft according to claim 2 wherein each of said plurality of primary wings is shaped to produce lift and has a rounded leading edge tapering toward a narrower trailing edge, in said upwardly oriented position said leading edge being higher than said trailing edge.

5. A tilt wing aircraft according to claim 1 wherein each of said plurality of power units is mounted distally on a corresponding one of said plurality of primary wings.

6. A tilt wing aircraft according to claim 2 wherein said plurality of tilt axes are coplanar.

7. A tilt wing aircraft according to claim 2 wherein said plurality of primary wings include a medial one that runs athwart said fuselage terminating in a right and a left end, said plurality of power units being separately mounted distally on said right and said left end of said medial one of said plurality of primary wings.

8. A tilt wing aircraft according to claim 1 wherein said plurality of primary wings each have a centrally notched trailing edge providing clearance for swinging into said upwardly oriented position and straddling said fuselage.

9. A tilt wing aircraft according to claim 2 wherein said plurality of power units each have a rotor.

10. A tilt wing aircraft according to claim 2 comprising.
a mechanism located in said fuselage and linked to each of said plurality of primary wings for rotating them synchronously

11. A tilt wing aircraft according to claim 2 wherein the plurality of primary wings includes a medial one located between two others, said medial one running athwart said fuselage and terminating in a right and a left end, said medial one having a leading and a trailing edge, said medial one having on said right end a leading right connector and a trailing right connector adjacent to said leading and said trailing edge, respectively, said medial one having on said left end a leading left connector and a trailing right connector adjacent to said leading and said trailing edge, respectively, said right brace having a pair of concavities providing clearance in said forwardly oriented position for said leading right connector and said trailing right connector, said left brace having a pair of concavities providing clearance in said forwardly oriented position for said leading left connector and said trailing left connector, a right one of said plurality of power units being connected to said right leading connector and said right trailing connector, a left one of said plurality of power units being connected to said left leading connector and said left trailing connector

12. A tilt wing aircraft according to claim 2 comprising:
a pair of ailerons mounted on some of said plurality of primary wings.

13. A tilt wing aircraft according to claim 2 comprising:
a tail having a rudder and a pair of elevators.

14. A tilt wing aircraft according to claim 2 wherein said plurality of power units are mounted subjacently on a foremost one of said plurality of primary wings.

15. A tilt wing aircraft according to claim 2 comprising:
a spaced plurality of complementary wings located behind said spaced plurality of primary wings and mounted on said fuselage, at least some of said plurality of complementary wings being operable to pivot in unison about corresponding ones of a parallel plurality of complementary axes between an upwardly oriented position and a forwardly oriented position, said plurality of complementary wings each having a wing length and at said fuselage a proximal width that is less than said wing length, in said forwardly oriented position said plurality of complementary wings having wing to wing gaps that are each less than the proximal width of any of the plurality of complementary wings; and
a right and a left propulsion unit mounted on one or more of said plurality of complementary wings to rotate in unison with at least some of said plurality of complementary wings between an upward propulsion position and a forward propulsion position, said right and said left propulsion unit being operable to rotate toward said upward propulsion position as said plurality of complementary wings rotate toward said upwardly oriented position.

16. A tilt wing aircraft according to claim 15 wherein said plurality of primary wings are operable to rotate in unison with at least some of said plurality of complementary wings.

17. A tilt wing aircraft according to claim 16 wherein said right propulsion unit is mounted on the foremost one of said plurality of complementary wings on the right, said left propulsion unit being mounted on the foremost one of said plurality of complementary wings on the left.

18. A tilt wing aircraft according to claim 16 wherein said right propulsion unit is subjacently mounted on the foremost one of said plurality of complementary wings on the right, said left propulsion unit being subjacently mounted on a foremost one of said plurality of complementary wings on the left.

19. A tilt wing aircraft according to claim 18 wherein a right one of said plurality of power units is subjacently mounted on the foremost one of said plurality of primary wings on the right, a left one of said plurality of power units being subjacently mounted on a foremost one of said plurality of primary wings on the left.

20. A tilt wing aircraft according to claim 16 wherein each of said plurality of complementary wings is longer than any of said plurality of primary wings.

21. A tilt wing aircraft according to claim 16 wherein each of said plurality of complementary wings have at least one distal tip, said aircraft comprising:
a right and a left bracket rotatably connected to the distal tips located on the left and on the right, respectively, of said fuselage.

22. A tilt wing aircraft according to claim 16 comprising:
a differential drive connected to a rearmost one of said plurality of complementary wings to angularly offset said rearmost one with respect to the other ones of said plurality of complementary wings in order to provide an elevator function.

23. A method for providing vertical takeoff capability with a spaced plurality of wings that are pivotally mounted on an aircraft fuselage and support a right and a left power unit, the method comprising the steps of:
placing the plurality of wings in an upwardly oriented position with the right and the left power unit in a position to provide upward propulsion;
powering the right and the left power unit sufficiently to create a downwash to lift the fuselage;
rotating the plurality of wings about a spaced plurality of tilt axes, the right and the left power unit rotating about one or more of the spaced plurality of tilt axes; and
reducing the angle of attack of the plurality of wings in order to facilitate forward motion of the fuselage and maintaining between them wing to wing gaps that are each less than the width of any of the plurality of wings as measured at the fuselage.

24. A method according to claim 23 wherein each of the plurality of wings produce lift at varying angles of attack.

25. A method according to claim 23 wherein each of the plurality of wings has a rounded leading edge tapering toward a narrower trailing edge, the step of producing a lesser angle of attack in the plurality of wings is performed by lowering their leading edges.

26. A method according to claim 23 comprising the step of:
synchronously producing a greater angle of attack in the plurality of wings and the right and the left power unit in order to retard forward motion of the fuselage.

27. A tilt wing aircraft comprising:
a fuselage;
a spaced plurality of wings mounted on said fuselage to pivot in unison about corresponding ones of a parallel plurality of tilt axes between an upwardly oriented position and a forwardly oriented position, said plurality of tilt axes being coplanar, said plurality of wings each having a wing length and at said fuselage a proximal width that is less than said wing length, in said forwardly oriented position said plurality of wings being disposed with wing to wing gaps that are each less than the proximal width of any of the plurality of wings, each of said plurality of wings being shaped to produce lift and having a rounded leading edge tapering toward a narrower trailing edge, in said upwardly oriented position said leading edge being higher than said trailing edge, said trailing edge of each of said plurality of wings having a central notch providing clearance for swinging into said upwardly oriented position and straddling said fuselage, each of said plurality of wings having at least one distal tip, said plurality of wings including a medial one that runs athwart said fuselage terminating in a right and a left distal tip, said medial one having at its right distal tip a leading right connector and a trailing right connector adjacent to said leading and said trailing edge, respectively, said medial one having at its left distal tip a leading left connector and a trailing left connector adjacent to said leading and said trailing edge, respectively;
a right and a left power unit, said right power unit being mounted on said leading right connector and said trailing right connector, said left power unit being mounted on said leading left connector and said trailing left connector, said right and said left power unit being mounted to rotate in unison with said plurality of wings about the tilt axis of said medial one of said plurality wings between a vertical propulsion position and a forward propulsion position, said right and said left power unit each having a rotor, said right and said left power unit being operable to rotate into said vertical propulsion position as said plurality of wings rotate into said upwardly oriented position;
a mechanism located in said fuselage and linked to each of said plurality of wings for rotating them synchronously;
a right and a left brace rotatably connected to the distal tips located on the left and on the right, respectively, of said fuselage, said right brace having a pair of concavities providing clearance in said forwardly oriented position for said leading right connector and said trailing right connector, respectively, said left brace having a pair of concavities providing clearance in said forwardly oriented position for said leading left connector and said trailing left connector, respectively;
a pair of ailerons mounted on some of said plurality of wings; and
a tail having a rudder and a pair of elevators.
